(19) United States
(12) Patent Application Publication
(10) Pub. No.: US 2011/0231364 A1
(43) Pub. Date: Sep. 22, 2011

(54) ID MANAGEMENT METHOD, ID MANAGEMENT SYSTEM, AND COMPUTER-READABLE RECORDING MEDIUM

(75) Inventors: Hiromi HASHIMOTO, Tokyo (JP); Yoshinori Honda, Kawasaki (JP); Susumu Serita, Chigasaki (JP); Yoji Shimizu, Tokyo (JP)

(73) Assignee: Hitachi, Ltd.

(21) Appl. No.: 13/021,255

(22) Filed: Feb. 4, 2011

(30) Foreign Application Priority Data
Mar. 19, 2010 (JP) 2010-64789

(51) Int. Cl. G06F 17/30

(52) U.S. Cl. 707/620; 707/E17.005

(57) ABSTRACT

Provided is an information processing apparatus 10 that executes a step of referring to a system list 115, retained in a storage unit, storing ID utilization status of each of other apparatuses when an ID change request is received by an input unit or a communication unit, to identify an other apparatus utilizing an ID to be changed indicated by the ID change request, a step of distributing change information relating to the ID to be changed indicated by the ID change request to the identified separate apparatus, and a step of referring to a business task database 113, retained in the storage unit, managing IDs of human resources, assets, and information allocated to business tasks, and identifying the ID to be changed indicated by the ID change request to make a change relating to the corresponding ID.

### CROSS-REFERENCE TO RELATED APPLICATIONS

The present application claims the benefit of priority to Japanese Patent Application No. 2010-64789, filed Mar. 19, 2010, of which full contents are incorporated herein by reference.

### BACKGROUND

The subject matter discussed herein relates to an ID management method, an ID management system, and an ID management program and particularly to a technique capable of managing, in a cross-cutting manner, IDs of human resources, assets, and information in an organization in consideration of a relationship with a business task such as a project.

Systems requiring personal identification at the time of access, etc., are recently increasing along with enhancement of security consciousness in organizations. For example, these systems correspond to a system that requires personal authentication using an ID or a password to utilize the system, such as an entry/exit management system that requires an IC card to be held over a card reader for entry into a building of an organization, and a locker with authentication function that requires an IC card to be held over a card reader for utilization of a personal locker. Such a system includes a wide variety of types from an IT system to a physical security system.

Introducing such a system requiring personal authentication reduces security risks such as unauthorized utilization of the system while leading to problems such as increase in time and trouble of system administrators and new security risks. For example, an administrator must perform ID registration/deletion/update operations for the users to utilize a system. When an authentication device such as IC cards, etc. are used, there requires operations for issuing IC cards, correlating IC cards with card users, etc.

Since these operations are performed for each system, IDs managed in each system may be inconsistent. For example, while a user ID is made unusable due to retirement of an employee in one system, there is a possibility that the user ID may still be usable in another system.

A system is proposed as a means for solving such a problem which is capable of automatically changing user group information in another server when the user group information is changed as in the technique disclosed in Japanese Laid-Open Patent Publication No. 2003-178030. This technique can considerably alleviate the burden of a system administrator by changing the user group information without the system administrator manually changing the user group information in a plurality of servers.

### SUMMARY

Those managed in an organization is not only personnel. Especially in companies, human resources, assets, and information are assigned to each group of business tasks, such projects where the comings and goings are managed in accordance with the progress of corresponding projects. These human resources, assets, and information are returned to their respective original business tasks during the period other than the period coupled to the project and the IDs thereof are separately managed. In such a case when an integrated ID management is attempted, not only for personnel but also for assets and information in an organization, mutual relations among assets, information, projects, etc., other than personnel would not be considered though an attempt to apply a conventional technology is made, and the result is that the administrator bears the burden of ID management operations for each system as has been done so conventionally.

For example, in the case of a system that manages IDs of items with the administrator in charge registered as in an asset management system, the consistency with another system handling the IDs of the items should be ensured, if IDs of items are managed with conventional technology. However, when the administrator in charge of the relevant item is transferred, measures cannot be taken to ensure the consistency with another system in relation with IDs of the relevant item taken into consideration. As a matter of course, it is more difficult to efficiently execute the operations for management such as registration, change, and deletion of IDs under situations involving human resources, assets, and information and their administrator authority for each project as described above.

Therefore, the present invention provides a technique of managing IDs of human resources, assets, and information in an organization in a cross-cutting manner. The present invention also provides a technique capable of managing IDs of human resources, assets, and information in an organization taking into consideration relationships with business tasks such as projects, in a cross-cutting manner.

In the disclosed ID management method for solving the above problems, an information processing apparatus, capable of communicating over a network with other apparatuses respectively controlling IDs of human resources, assets, and information includes an input unit, a communication unit, and a storage unit. The information processing apparatus executes the steps of referring to a system list, retained in a storage unit, storing an ID utilization status of each of the other apparatuses, when an ID change request is received by an input unit or a communication unit, and identifying an other apparatus utilizing an ID to be changed indicated by the ID change request; distributing change information relating to the ID to be changed indicated by the ID change request to the identified other apparatus; and referring to a business task database, retained in the storage unit, managing IDs of human resources, assets, and information allocated to business tasks, identifying the ID to be changed indicated by the ID change request, and making a change relating to the corresponding ID.

In an example, a disclosed ID management system is an information processing system capable of communicating over a network with other apparatuses respectively managing IDs of human resources, assets, and information, comprises an input unit; a communication unit; a storage unit; a unit of referring to a system list, retained in the storage unit, storing an ID utilization status of each of the other apparatuses when an ID change request is received by the input unit or the communication unit, and identifying an other apparatus utilizing an ID to be changed indicated by the ID change request; a unit of distributing, to the identified other apparatus, change information relating to the ID to be changed indicated by the ID change request; and a unit of referring to a business task database, retained in the storage unit, managing IDs of human resources, assets, and information allocated to business tasks, identifying the ID to be changed indicated by the ID change request, and making a change relating to the corresponding ID.

A computer-readable recording medium contains a computer software program causing an information processing apparatus capable of communicating over a network with other apparatuses respectively managing IDs of human resources, assets, and information, including an input unit, a communication unit, and a storage unit, to execute the steps of referring to a system list, retained in a storage unit, storing ID utilization status of each of the other apparatuses when an ID change request is received by an input unit or a communication unit, and identifying an other apparatus utilizing an ID to be changed indicated by the ID change request; distributing, to the identified separate apparatus, change information relating to the ID to be changed indicated by the ID change request; and referring to a business task database, retained in the storage unit, managing IDs of human resources, assets, and information allocated to business tasks, identifying the ID to be changed indicated by the ID change request, and making a change relating to the corresponding ID.

“ID” as used herein is an identifier capable of uniquely identifying a person, an item, and information.

According to the teaching herein, IDs of human resources, assets, and information in an organization can be managed in a cross-cutting manner. IDs of human resources, assets, and information in an organization can be managed taking into consideration relationships with business tasks such as projects in a cross-cutting manner.

These and other benefits are described throughout the present specification. A further understanding of the nature and advantages of the disclosed method and system may be realized by reference to the remaining portions of the specification and the attached drawings.

### BRIEF DESCRIPTION OF THE DRAWINGS

FIG. 1 is a diagram of an exemplary network configuration including an ID management system of the present embodiment.

FIG. 2 is a diagram of an exemplary hardware configuration of a client according to the present embodiment.

FIG. 3 is a diagram of an exemplary data structure of a user DB of the present embodiment.

FIG. 4 is a diagram of an exemplary data structure of an asset DB of the present embodiment.

FIG. 5 is a diagram of an exemplary data structure of an information DB of the present embodiment.

FIG. 6 is a diagram of an exemplary data structure of a system list of the present embodiment.

FIG. 7 is a diagram of an exemplary data structure of a business task DB of the present embodiment.

FIG. 8 is a diagram of an exemplary data structure of a collected log of the present embodiment.

FIG. 9 is a diagram of a process flow example 1 of an ID management method of the present embodiment.

FIG. 10 is a diagram of a process flow example 2 of the ID management method of the present embodiment.

FIG. 11 is a diagram of a process flow example 3 of the ID management method of the present embodiment.

FIG. 12 is a diagram of a display screen example 1 of the present embodiment.

FIG. 13 is a diagram of a display screen example 2 of the present embodiment.

FIG. 14 is a diagram of a display screen example 3 of the present embodiment.

### DETAILED DESCRIPTION OF THE EMBODIMENT

### —System Configuration—

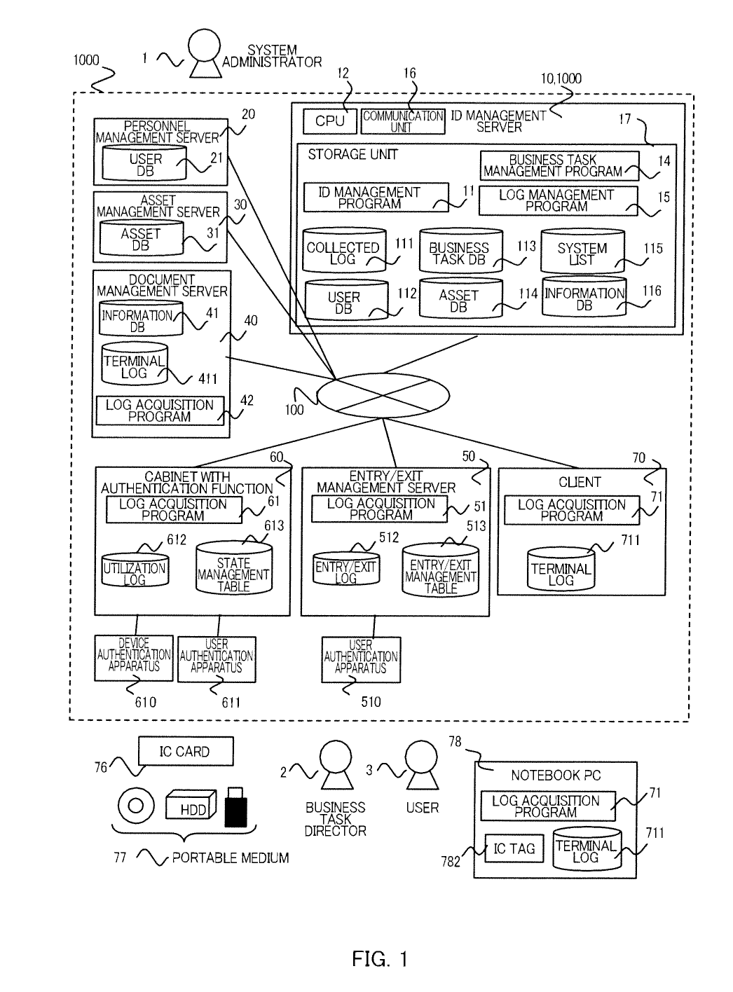

Examples will hereinafter be described with reference to the drawings as needed. FIG. 1 is a diagram of a network configuration including an ID management system according to the first example. The ID management system 1000 described in the present embodiment can be assumed to have a configuration with, for example, an ID management server 10 as an information processing apparatus (hereinafter, ID management server), a personnel management server 20, an asset management server 30, a document management server 40, an entry/exit management server 50, a cabinet with authentication function 60, and one or more clients 70 coupled through a wire or wirelessly to a network 100. Alternatively, the ID management server 10 may be considered as the ID management system 1000 since the ID management server 10 is responsible for substantial processes.

The ID management server 10 has a CPU 12 as an arithmetic device necessary for a computer, a storage unit 17, and a communication unit 16 such as a network interface card. The ID management server 10 can implement necessary functions by driving the CPU 12 to execute programs 11 to 15 retained in the storage unit 17. An input unit such as a keyboard and a mouse and an output unit such as a display may also be provided as needed.

As a matter of course, necessary communicating means such as network interface cards are included in the personnel management server 20, the asset management server 30, the document management server 40, the entry/exit management server 50, the cabinet with authentication function 60, and the clients 70. Unless otherwise stated, each of the apparatuses has at least a processing unit and a storage device necessary for a computer and can implement necessary functions by driving the processing unit to execute programs retained in the storage device. An input unit such as a keyboard and a mouse and an output unit such as a display may also be provided as needed.

The entry/exit management server 50 and the cabinet with authentication function 60 are only examples of a distribution destination of an ID managed by the ID management server 10, which is a system in which a change in ID is reflected, and are not limited to such. For example, various systems such as an authentication printing system and an attendance management system are possible. In the present embodiment, systems in which changes in ID are reflected will hereinafter be collectively called an “ID distribution destination system”. And as the “other apparatuses” in the example, the personnel management server 20, the asset management server 30, the document management server 40, the entry/exit management server 50, the cabinet with authentication function 60, and the client 70 are possible. The ID distribution destination systems may be other apparatuses or only a particular one of the other apparatuses.

The system administrator 1 is a person who manages master IDs (that is, IDs originally managed in the servers 20 to 40 other than the ID management server 10) stored in each of the personnel management server 20, the asset management server 30, and the document management server 40. The system administrator 1 has the authority to update the DB, that is a database for ID management included in each server. The system administrator 1 performs operations of issuing and deleting master IDs in the databases for ID management in accordance with personnel changes, purchase of new assets, and registration of new documents.

A business task director 2 is a person who accesses the ID management server 10 from the client 70 to arrange systems and assets necessary for conducting a business task, manage human resources, and monitor access logs to ensure compliance with the security policy when necessary for business.

A user 3 utilizes the ID distribution destination system by using at least one or more authentication methods. For example, the user 3 performs an authentication process with a user authenticating apparatus 510 coupled to the entry/exit management server 50 using an IC card 76 that has stored therein his/her user ID in a tamper-resistant region to enter/exit a predetermined area of an organization.

The information used for user authentication is not limited to the information stored in the IC card 76 and biological information such as finger veins may be used. The predetermined area of an organization can be assumed to be a building of a company, etc., or a room such as an office. The user authenticating apparatus 510 is disposed at the boundary of a predetermined area.

The user 3 can perform various operations by using portable mediums 77 such as a USB memory and an external hard disc, and a physical asset such as a notebook PC 78 with an IC tag 782 affixed, on which an asset number is written. The user 3 can use an ID and a password for personal authentication to utilize the client 70. The user 3 can access the ID management server 10 from the client 70 and can check systems and assets available to the user 3. As a general rule, the client 70 is allocated to each user. The client 70 may be allocated to two or more users and, in this case, the client 70 may recognize and authenticate a user with a predetermined program at the time of login, etc., for example, to distinguish a user who has utilized the client 70.

Software configurations will be described for the ID management server 10, the personnel management server 20, the asset management server 30, the document management server 40, the entry/exit management server 50, the cabinet with authentication function 60, and the client 70 with reference to FIG. 1. The ID management server 10 includes an ID management program 11, a business task management program 14, and a log management program 15.

### —ID Management Program—

When an ID change request is received from the client 70 by (the input unit or) the communication unit 16 of the ID management server 10, the ID management program 11 refers to a system list 115, retained in the storage unit 17, storing ID utilization statuses of each of the other apparatuses, to identify other apparatuses utilizing an ID to be changed indicated by the ID change request.

The ID management program 11 distributes to the identified other apparatuses the change information relating to the ID to be changed indicated by the ID change request. As a matter of course, the network addresses of the other apparatuses are stored in the storage unit 17 in advance.

The ID management program 11 acquires data of databases for ID management, which are a user DB 21, an asset DB 31, and an information DB 41, and retains the data as a user DB 112, an asset DB 114, and an information DB 116, respectively. In other words, the databases are synchronized.

The ID management program 11 checks the ID to be changed against the databases for ID management, which are the user DB 112, the asset DB 114, and the information DB 116, in the storage unit 17, to determine whether the ID is restricted from being changed in the corresponding databases for ID management and, if the ID to be changed is an ID restricted from being changed, a notification requesting to register an alternative proposal is transmitted via the communication unit 16 to an administrator terminal of the other apparatus retaining the corresponding database for ID management, which is at least one of the personnel management server 20, the asset management server 30, and the document management server 40, in this case. As a matter of course, the network addresses of the administrator terminals of the other apparatuses are stored in the storage unit 17 in advance.

The ID management program 11 receives data of the alternative proposal from the administrator terminal via the communication unit 16 to identify the other apparatus utilizing an alternative ID indicated by the alternative from the system list 115 and distributes change information relating to the alternative ID to the identified other apparatus.

The ID management program 11 checks the ID to be changed against the databases for ID management, which are the user DB 112, the asset DB 114, and the information DB 116, in the storage unit 17 to determine whether the ID is restricted from being changed in the corresponding databases for ID management and, if the ID to be changed is an ID restricted from being changed, alert information is (output to the output unit or) transmitted via the communication unit 16 to the transmission source terminal of the ID change request, that is the client 70.

When the ID change request received from the client 70 by (the input unit or) the communication unit 16 indicates a new registration ID, the ID management program 11 refers to the system list 115 for storing ID utilization statuses of each of the other apparatuses, retained in the storage unit 17, to identify other apparatuses utilizing the ID to be newly registered indicated by the ID change request, and (outputs to the output unit or) transmits via the communication unit 16 to the client 70 that is a transmission source terminal of the ID change request a list of the identified other apparatuses.

The ID management program 11 receives information of a corresponding other apparatus selected from the list from (the input unit or) the client 70 that is the transmission source terminal via the communication unit 16, and distributes change information relating to the ID to be newly registered indicated by the ID change request to the corresponding separate apparatus.

### —Business Task Management Program—

Meanwhile, the business task management program 14 refers to the business task database 113, retained in the storage unit 17, for managing IDs of human resources, assets, and information allocated to business tasks and identifies the ID to be changed indicated by the ID change request (received from the client 70), to make a change relating to the corresponding ID.

The business task management program 14 refers to the business task database 113, retained in the storage unit 17, for managing IDs of human resources, assets, and information allocated to business tasks and identifies the alternative ID (ID indicated by the data of the alternative proposal received from the administrator terminal by the ID management program 11) to make a change relating to the corresponding ID.

The business task management program 14 receives a business task registration request including designations relating to a business task to be registered and human resource, asset or information to be allocated to the business task from the client 70 by (the input unit or) the communication unit 16 and registers the business task and an ID of the human resource, asset or information to be allocated thereto in the business task database 113.

The business task management program 14 searches the system list 115 with the ID of the human resource, asset or information indicated by the business task registration request to identify an other apparatus utilizing the ID indicated by the business task registration request and distributes change information relating to the ID indicated by the business task registration request to the identified other apparatus.

When the business task registration request is received, the business task management program 14 also receives a designation of workplace of the business task, then searches the system list 115 with the information of the workplace to identify other apparatuses including the workplace as place of use and (outputs to the output unit or) transmits via the communication unit 16 to the client 70 that is a transmission source terminal of the business task registration request a list of the identified other apparatuses.

The business task management program 14 receives information of a corresponding other apparatus selected from the list from (the input unit or) the client 70 that is the transmission source terminal via the communicating unit 16, and distributes change information relating to the ID indicated by the business task registration request to the corresponding other apparatus.

### —Log Management Program—

Meanwhile, the log management program 15 acquires log data of various operations recorded for IDs to be managed from the other apparatuses, which are the personnel management server 20, the asset management server 30, the document management server 40, the entry/exit management server 50, the cabinet with authentication function 60, and the client 70, and retains the log data as a collected log 111 in the storage unit 17.

The log management program 15 extracts log data of corresponding IDs from the storage unit 17 for an ID group allocated to each business task in the business task database 113 or for each ID included in the log data, that is the collected log 111, retained in the storage unit 17 and outputs the log data (to the output unit or) to a predetermined terminal such as the client 70 via the communication unit 16.

The log management program 15 acquires data of the databases for ID management (that is the user DB 21, the asset DB 31, and the information DB 41) from the other apparatuses (the personnel management server 20, the asset management server 30, and the document management server 40) and retains the data in the storage unit 17.

When a log browsing request is received from (the input unit or) the client 70 via the communication unit 16, the log management program 15 uses an ID of a person who is interested in browsing indicated by the log browsing request as a key to identify an asset or information whose administrator is the corresponding person in the databases for ID management, or a business task, with which the corresponding person is involved, in the business task database 113, and uses an ID of the identified asset or information or ID group allocated to the business task as a key to extract log data of the corresponding ID from the storage unit 17 to output the log data (to the output unit or) to a predetermined terminal such as the client 70 via the communication unit 16.

### —Servers Managing Master ID—

The personnel management server 20 stores and manages the user DB 21, which is master data of IDs of persons belonging to an organization (hereinafter, user IDs). The asset management server 30 stores and manages the asset DB 31, which is master data of IDs of various assets such as PC and furniture managed by the organization (hereinafter, asset IDs). The document management server 40 stores and manages the information DB 41, which is master data of IDs of information assets (e.g., electronic files) (hereinafter, information IDs) managed by the organization. The document management server 40 includes a log acquisition program 42 that acquires a log (e.g., information such as a user ID, an ID of a utilized information asset, and date of utilization) in association with utilization of an information asset by a user via the client 70. The acquired log is accumulated in a terminal log 411 and periodically transmitted to the ID management server 10 by the log acquisition program 42.

### —ID Distribution Destination Systems—

The entry/exit management server 50 reads the IC card 76 or biological information belonging to the user 3 with the user authenticating apparatus 510, checks the read result against an entry/exit management table 513 to authenticate whether or not the read result is a registered one, and transmits an open/close control signal to a mechanism such as a door. Although not particularly depicted, it is a matter of course that the entry/exit management table 513 stores the user IDs and the biological information in a correlated manner. The entry/exit management server 50 includes a log acquisition program 51 that acquires an entry/exit log 512 when the door is opened and closed by performing user authentication. The acquired entry/exit log 512 includes information, for example, the user ID of a person who enters/exits, the date of entry/exit, and the place of entry/exit, and is transmitted periodically or in real time to the ID management server 10 by the log acquisition program 51.

The cabinet with authentication function 60 includes a computer communicably coupled to the network 100 and is configured as a common cabinet and also includes a user authenticating apparatus 611 and a device authenticating apparatus 610. The computer of the cabinet with authentication function 60 checks the user's authenticating information acquired from the user authenticating apparatus 611 against a state management table 613 and sends an unlock signal to a door mechanism of the cabinet if the user ID of the user performing the authentication operation is stored in the state management table 613. Although not particularly depicted, the state management table 613 is a table that stores user IDs of users capable of utilizing the cabinet with authentication function 60 and asset IDs of assets stored in the cabinet.

The computer of the cabinet with authentication function 60 includes a log acquisition program 61 that acquires a utilization log 612 that records open/close time of the cabinet door, user information, etc., when a user is authenticated and utilizes the cabinet. The acquired utilization log 612 is transmitted periodically or in real time to the ID management server 10 by the log acquisition program 61.

“Assets” described in this embodiment covers all assets generated in an organization or purchased/acquired from outside and having value in the organization and are uniquely identified by affixing IC tags 782 thereto, for example.

### —Client—

The client 70 and the notebook PC 78 include a log acquisition program 71 that monitors in detail of the operations by the user 3, for example, operation when the portable medium 77 is coupled and input/output of information, stores the result of an operation as a log in a terminal log 711 when an operation occurs, and transmits the log to the ID management server 10. To the client 70, etc., the portable mediums 77 can be coupled such as CD-R/DVD-R, USB flash memory, portable HDD, and SD card storing multimedia contents, and the client 70, etc. and the client 70 can exchange files with these portable mediums 77.

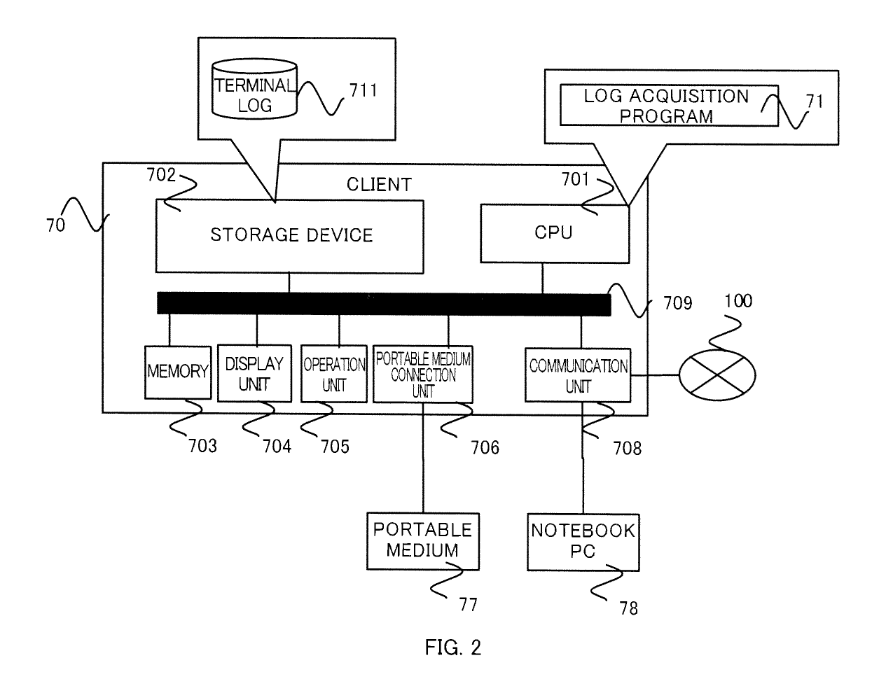

FIG. 2 is a diagram of an exemplary hardware configuration of the client 70. The client 70 is configured with a storage device 702 that stores the terminal log 711, a CPU 701 that executes the log acquisition program 71, a memory 703, a display unit 704 that displays input/output screens, an operating unit 705 that controls input/output, a portable medium coupling unit 706 for reading/writing data stored in the portable medium 77, a communication unit 708 that communicates through the network 100 by wired or wireless connection, and a bus 709 that couples these devices to each other. The notebook PC 708, etc., can also be coupled to the communicating unit 708.

### —Structure of Database, etc.—

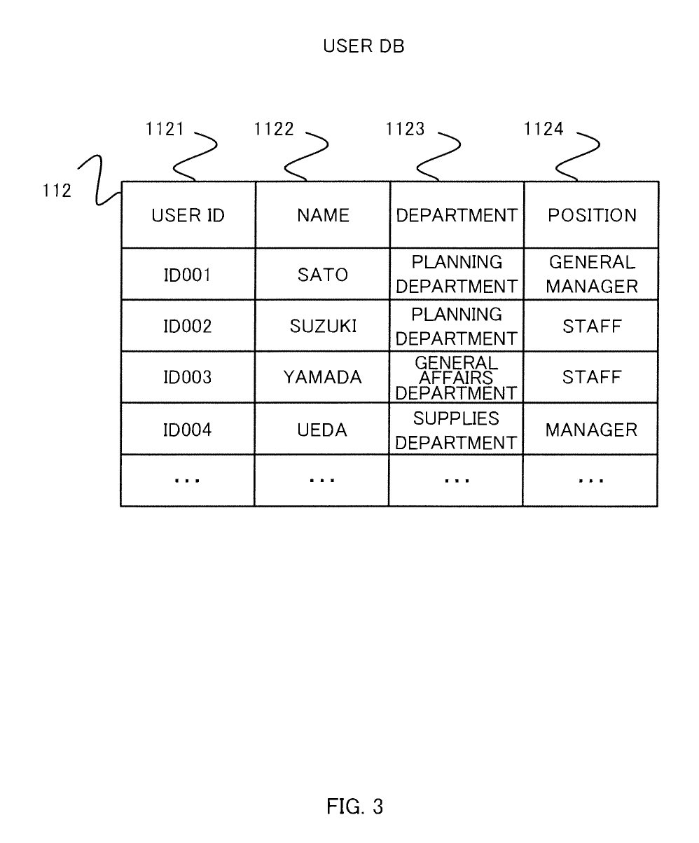

The data structures of the databases utilized by the ID management server 10 will then be described. FIG. 3 depicts an example of a data structure of the user DB. The user DB 112 is for the purpose of uniquely identifying and managing IDs and attributes of persons under management of an organization and is stored in the storage unit 17 of the ID management server 10.

The user DB 112 is table data consisting of zero or more entries using a user ID 1121 capable of uniquely identifying a person belonging to the organization as a key to correlate data such as names 1122, departments 1123, and positions 1124. The information of the user DB 112 is synchronized with the user DB 21 managed by the personnel management server 20 and, when the user DB 21 is updated in the personnel management server 20, the user DB 112 is synchronized by the ID management program 11 of the ID management server 10 to ensure the consistency. The asset DB 114 and the information DB 116 described below are synchronized with the asset DB 31 of the asset management server 30 and the information DB 41 of the document management server 40, respectively.

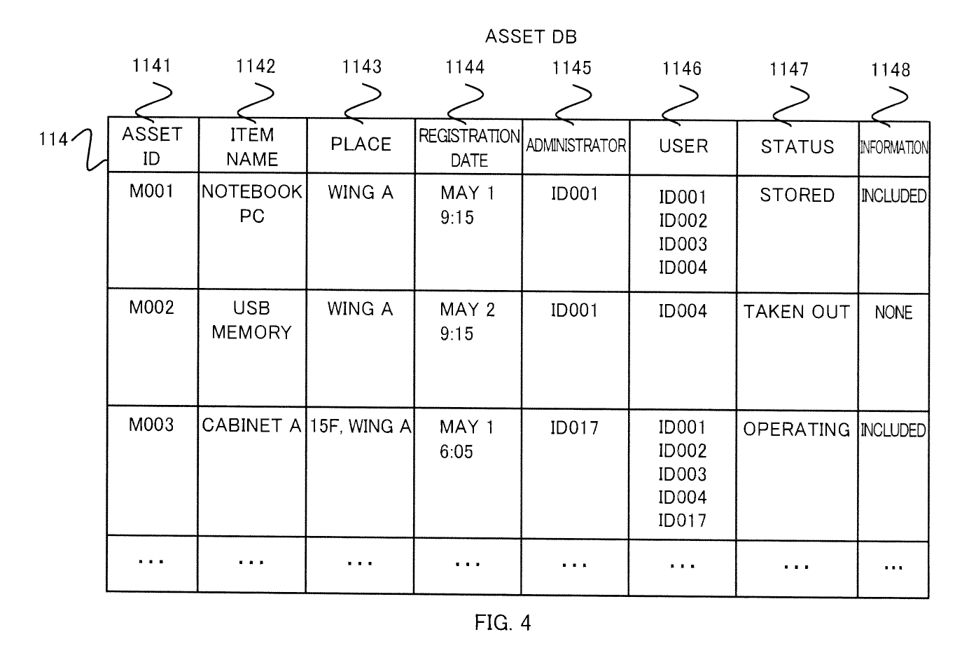

FIG. 4 depicts an example of a data structure of the asset DB 114. The asset DB 114 is for the purpose of uniquely identifying and managing IDs and attributes of physical assets managed by an organization and is stored in the storage unit 17 of the ID management server 10.

The asset DB 114 is a table data consisting of zero or more entries using an asset ID 1141 capable of uniquely identifying a physical asset belonging to the organization as a key to correlate data such as the item name 1142, place 1143 indicative of an installation site or storage, registration date 1144 of an asset, user 1146 registered user IDs having authority to utilize assets, a status 1147 of an asset, information 1148 indicative of whether or not information is stored in an asset such as a notebook PC or the portable medium 77 capable of storing information.

Among data registered in the asset DB 114, data of the user 1146 comes from the user ID registered in the user DB 112 described above and, for example, when a user ID of a certain person is deleted from the user DB 112 due to retirement, etc., the user ID of the same person registered in an administrator 1145 or the user 1146 of the asset DB 114 is also deleted. The ID management server 10 in the present embodiment identifies with the ID management program 11 that a person with the user ID to be deleted is set as the administrator 1145, and notifies (a terminal, etc., of) the system administrator 1 of setting of a substitute administrator. This can prevent the inconsistency in user IDs shared by the DBs (in this case, the user DB 112 and the asset DB 114) and the occurrence of situations such as an absence of an administrator.

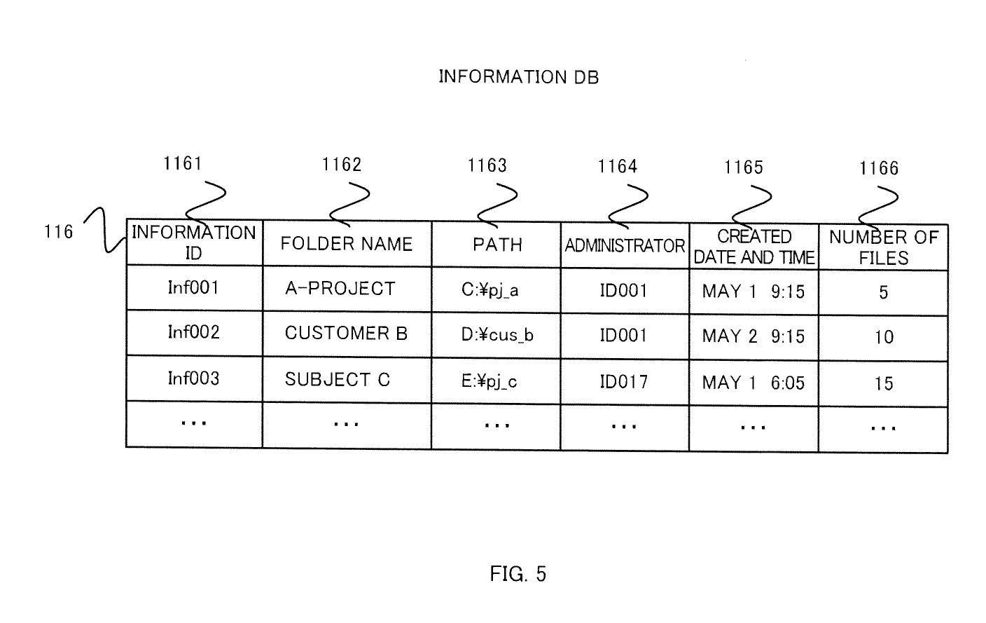

FIG. 5 depicts an example of a data structure of the information DB 116. The information DB 116 is for the purpose of uniquely identifying and managing IDs and attributes of information assets managed by an organization and is stored in the storage unit 17 of the ID management server 10. The information DB 116 is table data consisting of zero or more entries using an information ID 1161 capable of uniquely identifying an information asset belonging to the organization as a key to correlate data such as a folder name 1162 of a storage location, a folder path 1163, created date and time 1165 of a folder, and the number of stored files 1166.

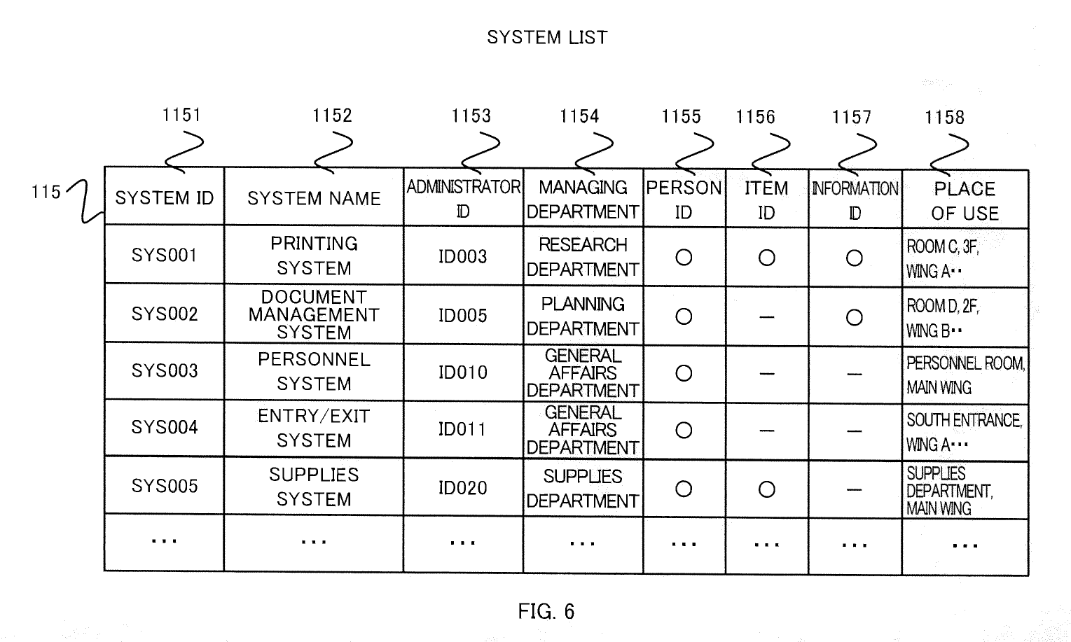

FIG. 6 depicts an example of a data structure of the system list 115. The system list 115 is a table that stores a list of the above described ID distribution destination systems and is stored in the storage unit 17 of the ID management server 10. As described above, the ID distribution destination systems are systems that are coupled via the network 100 to the ID management server 10 and are distribution destinations of ID information managed by the ID management server 10, that is distribution of change information.

The system list 115 is table data consisting of zero or more entries using a system ID 1151 capable of uniquely identifying a system under the management of the organization as a key to correlate data such as a system name 1152, an administrator ID 1153 storing a user ID of a system administrator, a managing department 1154 of a system, a person ID 1155 indicative of a utilization status of a user ID in the system, an item ID 1156 indicative of a utilization status of an asset ID in the system, an information ID 1157 indicative of a utilization status of an information asset in the system, and a place of use 1158 of the system.

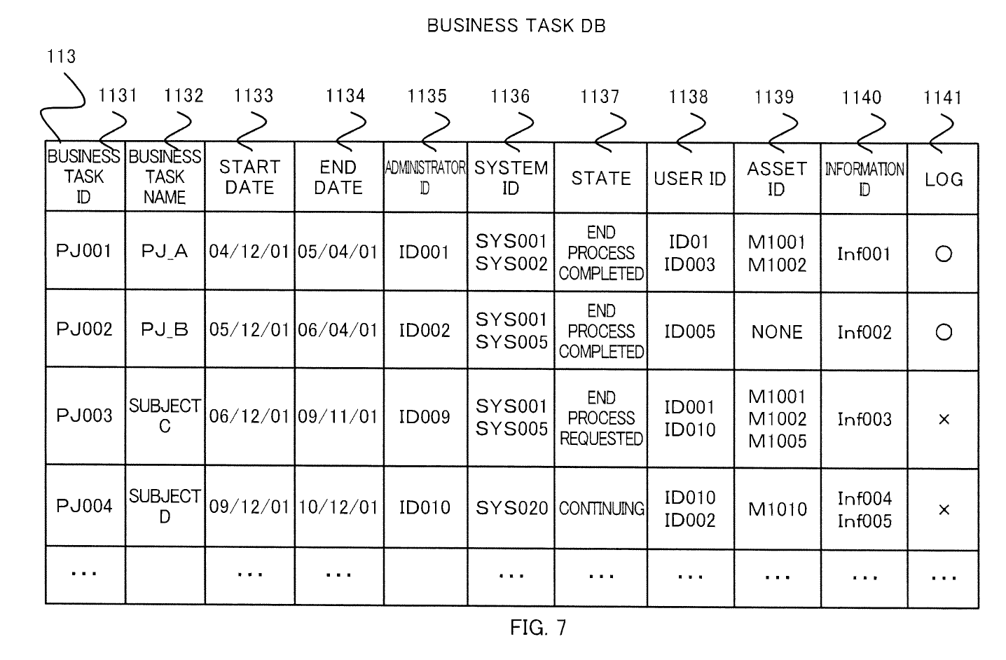

FIG. 7 depicts an example of a data structure of the business task DB 113. The business task DB 113 is for the purpose of uniquely identifying and managing business tasks such as projects that have been conducted or is being conducted under an organization and is stored in the storage unit 17 of the ID management server 10.

The business task DB 113 is table data consisting of zero or more entries using business task IDs 1131 capable of uniquely identifying a project that had been conducted or is being conducted in the organization as a key to correlate data such as a start date 1133 of a business task, an end date 1134, system ID 1136 of an ID distribution destination system utilized in a business task, a state 1137 indicative of an operating state of a business task, a user ID 1138 of persons engaged in a business task, an asset ID 1139 indicative of assets utilized in a business task, information IDs 1140 indicative of information assets utilized in a business task, and a presence of an acquired log 1141. An entry of the business task DB 113 is registered by the business task director 2 accessing the business task management program 14 of the ID management server 10 at the start of a business task and the authority to utilize various IDs and systems is managed based on this DB during operation of the business task.

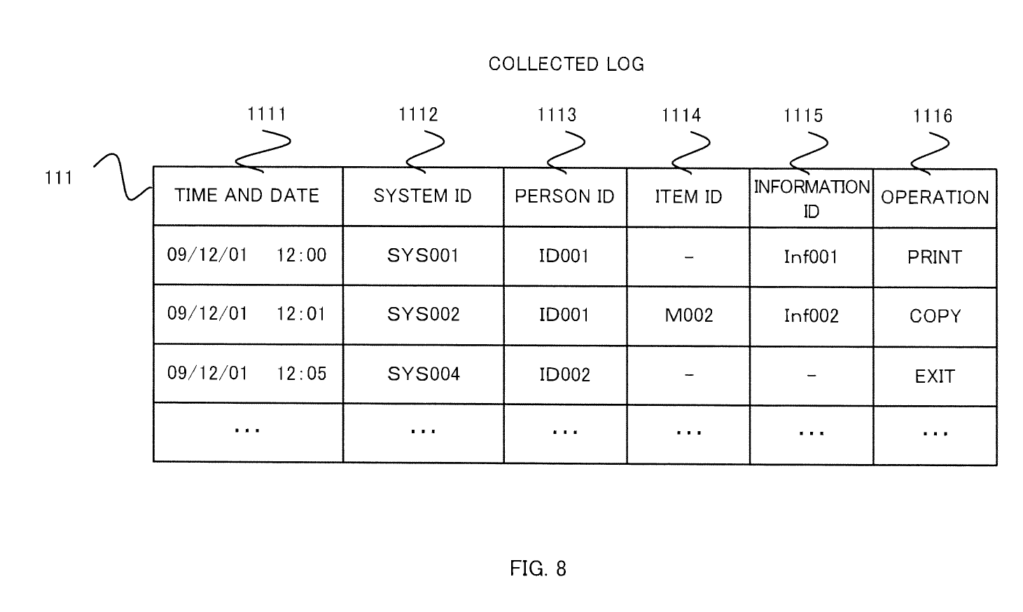

FIG. 8 depicts an example of a data structure of the collected log 111. The collected log 111 is formed on the ID management server 10 by collecting and formatting the log collected by the systems coupled to the ID management server 10 from the other apparatuses. The collected log 111 is stored in the storage unit 17 of the ID management server 10.

The collected log 111 is table data consisting of zero or more entries including data such as time and date 1111 when an operation occurs in each system, a system ID 1112 indicative of a system that acquires the log, ID, written in the log, classified into types (user ID, asset ID, and information ID) being person ID 1113, object ID 1114, information ID 1115, and a generated operation 1116.

The log accumulated in the systems is uploaded in real time or periodically to the ID management server 10 and stored based on the format of the collected log 111 described above by the log management program 15 of the ID management server 10. Collecting and accumulating the log in this way enables the log management program 15 to display the log upon request from the business task director 2 or the user 3.

### Process Flow Example 1

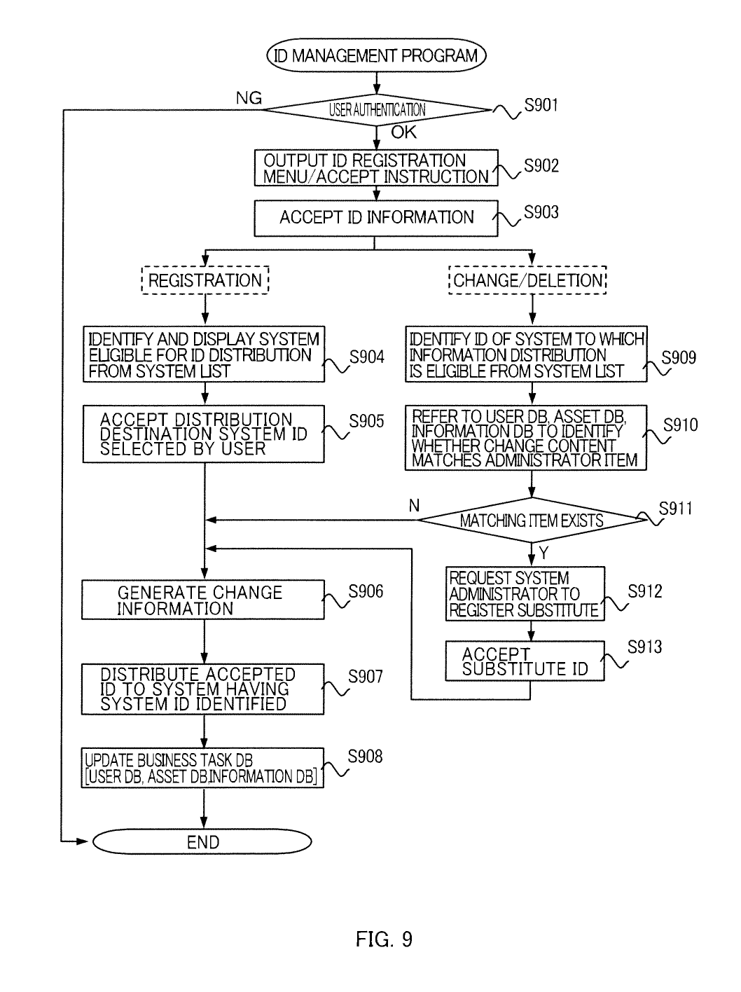

FIG. 9 is a diagram of a process flow example 1 of an ID management method of the present embodiment. A process flow of the ID management program 11 will be described. The ID management program 11 is utilized by the system administrator 1. First, it is assumed that the system administrator 1 accesses the ID management server 10 from the client 70 of the system administrator 1.

In this case, the ID management program 11 of the ID management server 10 performs user authentication by checking a user ID and a password received from the client 70 against a predetermined authentication table, for example (S901). When the user authentication fails (S901: NG), the process terminated. In contrast, if the user authentication succeeds (S901: OK), the ID management program 11 reads screen data of an ID registration menu from the storage unit 17 and returns the screen data to the client 70 (S902). The ID management server 10 may retain menu screens corresponding to the user given the authority to utilize (such as job title) in the storage unit 17 in advance and may display a menu corresponding to the authority to use of the accessing user. For example, the ID registration menu is a menu displayed only for the system administrator 1.

At step S902, the ID management program 11 accepts an operation instruction from the client 70 for either registration or change/deletion of ID selected on the TD registration menu by the system administrator 1.

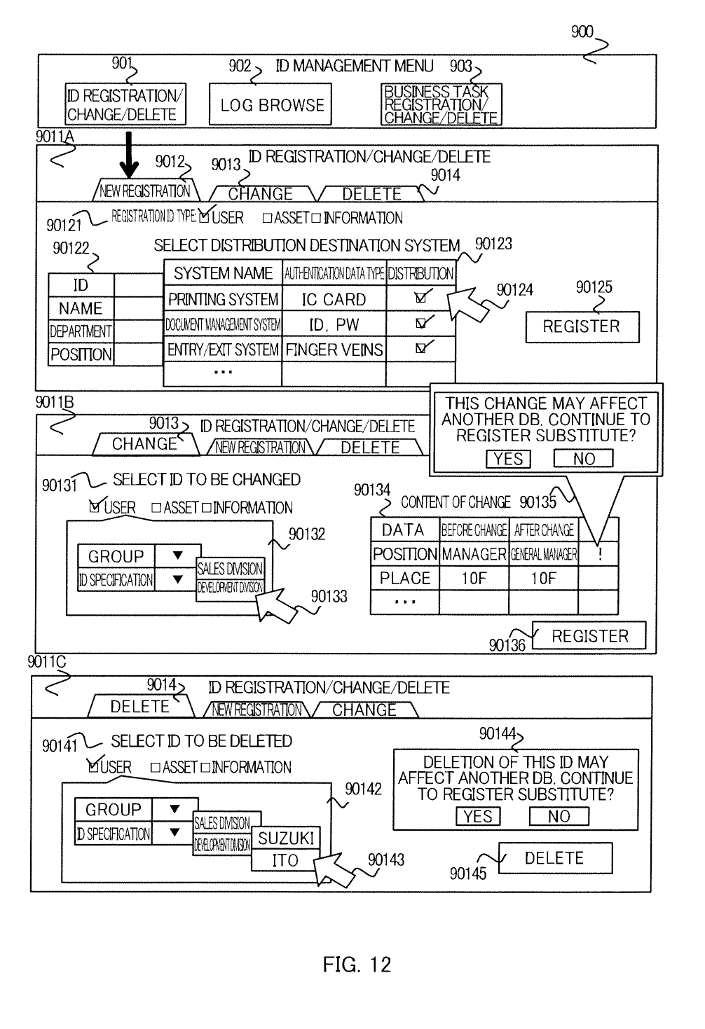

The ID management program 11 subsequently accepts information of an ID to be subjected to the process such as registration or change/deletion (S903). This is performed by, for example, accepting specification of an ID to be registered and allowing the system administrator 1 to select whether the ID type thereof is a person, asset, or information. The interface accepting this instruction will be described with reference to FIG. 12.

After accepting the information of the ID to be processed from the client 70, when the operation selected by the system administrator 1 at step S902 is “registration”, the ID management program 11 refers to the system list 115 and identifies other apparatuses utilizing an ID of the same type as the ID having information accepted at step S903 (that is the ID to be changed indicated by the ID change request) (S904). For example, if the type of the ID having information accepted at step S903 is an ID of a “user”, the other apparatuses utilizing the user ID are identified.

At step S904, the ID management program 11 extracts information relating to the identified other apparatuses from the system list 115 and presents the information to the client 70 of the system administrator 1. For example, when the ID to be processed specified by the system administrator 1 is a user ID, the systems having a “circle” entered in the person ID 1155 are identified in the case of the example of the system list 115 depicted in FIG. 6, because a user ID is an ID for a “person”. For example, pieces of information of a “printing system”, a “document management system”, a “personnel system”, an “entry/exit system”, and a “supplies system” are extracted.

The ID management program 11 may distribute the change information relating to the ID to be processed acquired at step S903 to the other apparatuses identified at step S904 without presenting information relating to the other apparatuses to the client 70 as described above. This change information is information including information of the ID to be processed and instructing one of new registration, change, and deletion.

It is assumed that the system administrator 1 selects one other apparatus on the client 70 from the other apparatuses presented at step S904. In this case, the ID management program 11 receives information, from the client 70, of the other apparatus selected by the system administrator 1, which is the system that is the distribution destination of the ID, and identifies the system ID of the selected system (S905). In the above example, for example, when the “entry/exit system” is selected by the system administrator 1, the ID management program 11 acquires “SYS004” as the corresponding system ID.

The ID management program 11 refers to a DB related to the ID to be processed accepted from the client 70 to acquire a format, etc., and generates change information to be transmitted to the system identified at step S905 (S906). For example, when a new user ID registration is accepted from the system administrator 1, reference is made to the user DB 112 that manages user IDs and data is processed into a format same as that of the user DB 112 to generate the change information.

On the other hand, when the content of operation selected by the system administrator 1 at step S902 is “change” or “deletion”, the ID management program 11 refers to the system list 115 and identifies IDs of systems that utilize IDs of the same type as the ID having information accepted at step S903 (that is, ID to be changed indicated by the ID change request) and that are destinations of change information (S909). This process is the same as step S904.

The ID management program 11 subsequently refers to the user DB 112, the asset DB 114, and the information DB 116 to determine whether the ID to be processed accepted from the system administrator 1 matches an ID being restricted from being changed in these DBs (S910, S911). For example, the administrator 1145 in the asset DB 114 must always be set to the user ID of the administrator. Therefore, the restriction from being changed in this case is related to the user ID of the administrator 1145. For example, when a user ID is the ID to be processed and is set as the administrator of a certain asset included in the asset DB, inconsistency is caused unless information of the administrator on the asset DB is changed in addition to the updating of the user DB.

When it is determined at step S911 that the ID to be processed matches an ID being restricted from being changed in any one DB (the user DB, the asset DB, the information DB) (S911: Y), the ID management program 11 transmits a request for an alternative proposal, such as a request to register a substitute, to a terminal of a system administrator of the DB affected by this “change” or “deletion” of ID (S912). In contrast, when the ID to be processed matches no ID being restricted from being changed at step S911 (S911: N), the ID management program 11 shifts the process to step S906.

When the ID to be processed matches an ID being restricted from being changed in any one DB (the user DB, the asset DB, the information DB) at step S911 (S911: Y), the ID management program 11 may (output to the output unit or) transmit alert information indicative of the necessity of an alternative plan via the communication unit 16 to a transmission source terminal of the ID change request, that is the client 70.

Subsequent to step S912, the ID management program 11 receives data of the alternative plan via the communication unit from the terminal of the system administrator (S913), identifies the other apparatus utilizing an alternative ID indicated by the alternative plan on the system list 115, and generates change information relating to the alternative ID for the identified other apparatus (S906).

The ID management program 11 distributes the change information generated at step S906 above to a system of the system ID identified at S905 or S909 (S907). For the ID to be processed, the ID management program 11 then performs updates (new registration, change, deletion) of the business task DB 113 and the DB handling IDs of the same type as the ID to be processed (the user DB 112, the asset DB 114, or the information DB 116) (S908).

### Process Flow Example 2

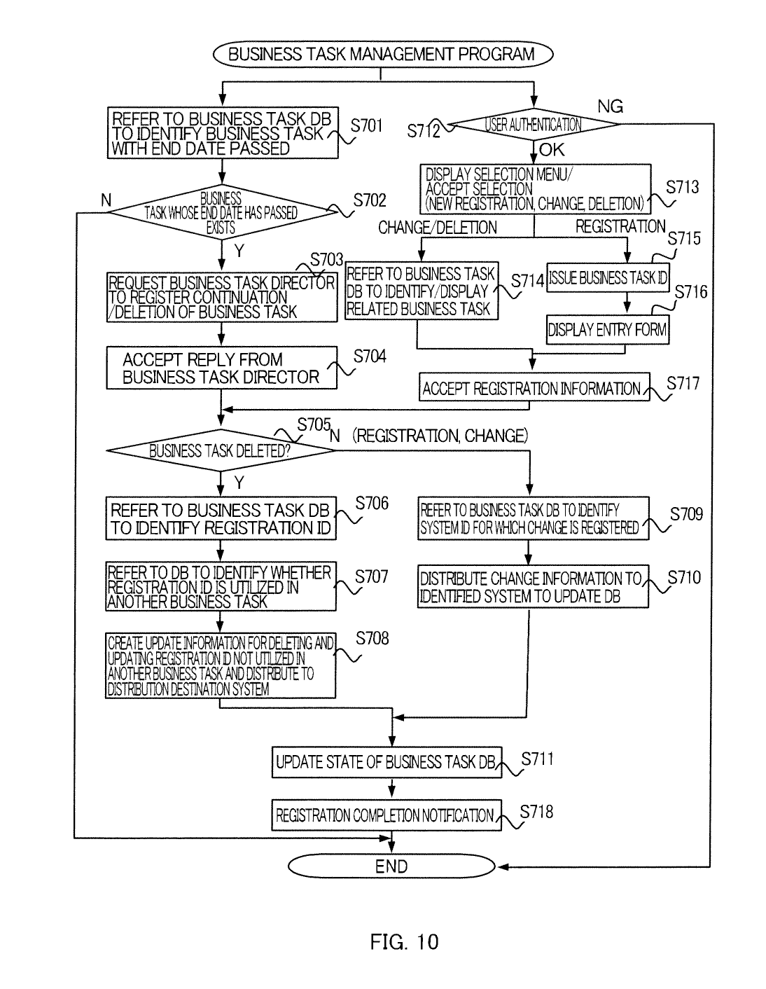

FIG. 10 is a diagram of a process flow example 2 of the ID management method of the present embodiment. A process of the business task management program 14 of the ID management server 10 will then be described. The business task management program 14 is utilized when the business task director 2 accesses the ID management server 10 from the client 70 to temporarily allocate the authority to utilize an asset of an organization for a project, for example. For a business task after the business task end date, the business task management program 14 also cancels the authority set in association with the end of the business task. Since the business task management program 14 manages IDs of persons, assets and information on the basis of a business task, the business task management program 14 can collectively allocate the authority to utilize even when assets belong to different managing departments and can collectively reset the authority to utilize in association with the end of the business task regardless of ID type. Therefore, the efforts of the administrator associated with registration and deletion can be reduced and the inconsistency of IDs can be eliminated between the systems.

It is first assumed that the business task director 2 accesses the ID management server 10 from the client 70. In this case, the business task management program 14 of the ID management server 10 performs user authentication by checking the user ID and the password received from the client 70 against the predetermined authentication table, for example (S712). If the user authentication fails (S712: NG), the process is terminated.

In contrast, if the user authentication succeeds (S712: OK), the business task management program 14 reads screen data of a selection menu for operations related to a business task from the storage unit 17 and returns the screen data to the client 70 (S713). The selection menu includes options for newly registering, changing, and deleting a business task, for example, and the business task director 2 selects a desired operation icon, etc., on the client 70. At step S713, the business task management program 14 accepts a selection selected from the selection menu from the client 70.

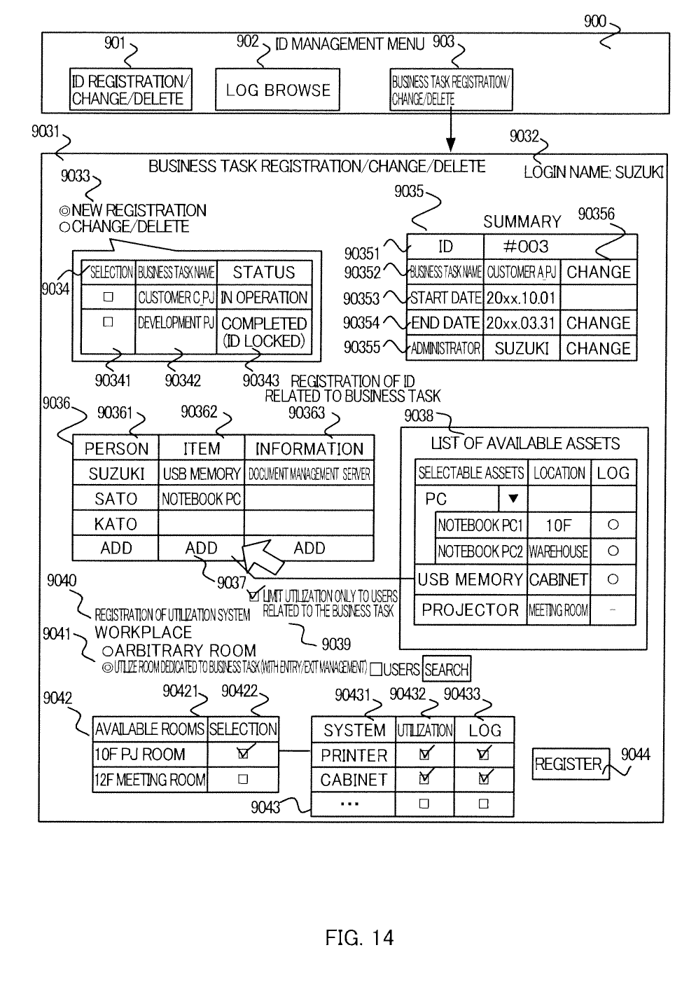

If the selection accepted at step S713 is “registration”, the business task management program 14 newly issues a business task ID in accordance with a predetermined algorithm such as that sequentially increments the final number of an ID (S715) and returns to the client 70 an entry form necessary to register the business task (S716). Details entered in the entry form by the business task director 2 at the time of registering the business task will be described with reference to FIG. 14.

The business task director 2 browses the entry form on the client 70 and registers various pieces of information relating to the business task with the entry form. In this case, the business task management program 14 accepts the registration information of the business task from the client 70 by way of the entry form (S717).

On the other hand, if the selected content accepted at step S713 is “change” or “deletion”, the business task management program 14 refers to the business task DB 113 to identify the business task including the user ID authenticated at step S712 and transmits information of the corresponding business task to the client 70 (S714). The business task director 2 browses the information of the corresponding business task on the client 70 to check/instruct the contents of change, etc. The business task management program 14 accepts information of the change or deletion instructed on the client 70 by the business task director 2 (S717).

If the contents of operation accepted at step S713 is “deletion” (S705: Y), the business task management program 14 refers to the business task DB 113 and identifies the ID to be deleted (which can be assumed to be any one of a business task ID, a user ID, an asset ID, and an information ID) indicated by the information accepted at step S717 (S706).

The business task management program 14 refers to the business task DB 113 and identifies whether the ID to be deleted is utilized in another business task (S707). This is for the purpose of identifying whether the DBs handling IDs of other types are affected by deleting the ID requested to be deleted from the business task DB 113. Therefore, the business task management program 14 searches the system list 115 for the ID to be deleted and identifies the affected other apparatus.

For the ID to be deleted not utilized in another business task, the business task management program 14 generates and distributes change information that is an instruction to delete the ID, to a corresponding other apparatus (distribution destination system) (S708). The business task management program 14 deletes the ID to be deleted in the business task DB 113 to update its state (S711) and sends a registration completion notification to the client 70 of the business task director 2 (S718).

On the other hand, at step S705, if the content of operation accepted at step S713 is “registration” or “change” (S705: N), the business task management program 14 refers to the business task DB 113 and searches the system list 115 for the ID to be processed to identify the system ID of an affected other apparatus (S709). The business task management program 14 distributes change information to the distribution destination system, etc., corresponding to the system ID to update the DB of the distribution destination system (S710). For the change information distributed in this case, change information is generated by referring to the DB related to the ID to be processed to acquire a format, etc., and by processing data into the acquired format, as is the case with the process executed at step S906.

The business task management program 14 subsequently updates the state of the business task DB 113 (S711) and notifies the business task director 2 of the registration completion (S712) as described above and terminates the process. The update of the state of the business task DB 113 is performed by, for example, registering a business task and an ID of human resource or asset or information allocated thereto into the business task database 113 in accordance with designation information related to a business task to be registered accepted at step S717 from the client 70, and human resources, asset or information allocated to the business task.

Although description has been made of the case where the business task director 2 utilizes the business task management program 14, a process autonomously-executed by the business task management program 14 is also assumable. In this situation, at least one or more business tasks are registered in the business task DB 113 and the business task management program 14 manages the registered business task end dates. Description will hereinafter be made in detail.

The business task management program 14 periodically refers to the business task DB 113 and checks data for the end date 1134 to identify a business task whose end date has passed (S701). If no business task whose end date has passed can be identified (S702: N), the process is terminated.

In contrast, if a business task whose end date has passed is identified (S702: Y), the business task management program 14 sends a request notification to the client 70 of the business task director 2, asking whether the corresponding business task is to continue or to be deleted (S703). Specifically, the request notification may be sent at the timing the client 70 of the business task director 2 accesses the ID management server 10 or an e-mail maybe transmitted to the mail address (known in the ID management server 10) of the business task director 2.

The business task management program 14 then accepts a reply, corresponding to the request notification from the client 70, from the business task director 2 (S704) and executes the processes following step S705 in accordance with the continuation or deletion of the business task indicated by the reply.

By implementing the process flow described above, the business task director 2 can perform, at one time, the requests for allocation of human resources, assets, information, etc., to a business task, which has conventionally been performed by each managing departments and thereby system administrator 1 can reduce the efforts to ensure consistency with systems outside the control of the system administrator 1.

The business task management program 14 preferably refers to the business task database 113 and identifies an alternative ID (ID indicated by data of the alternative plan received by the ID management program 11 from the client 70 of the system administrator 1 at step S913 of the process flow example 1) to make a change relating to the corresponding ID.

For example, when accepting the contents of registration of a business task at step S717, the business task management program 14 may also accept a designation of a workplace of the business task and searches the system list 115 for the information of the workplace to identify other apparatuses including the workplace as the place of use 1158. In this case, the business task management program 14 (outputs to the output unit or) transmits via the communicating unit 16 to the client 70 that is the transmission source terminal of the registration request of the business task, a list of the identified separate apparatuses. The business task management program 14 then receives information of a corresponding other apparatus selected from the list of the other apparatuses from (the input unit or) from the client 70 via the communicating unit 16 and distributes the change information relating to the ID indicated by the registration request of the business task to the corresponding other apparatus. The process relating to the workplace will also be described with reference to FIG. 14.

### Process Flow Example 3

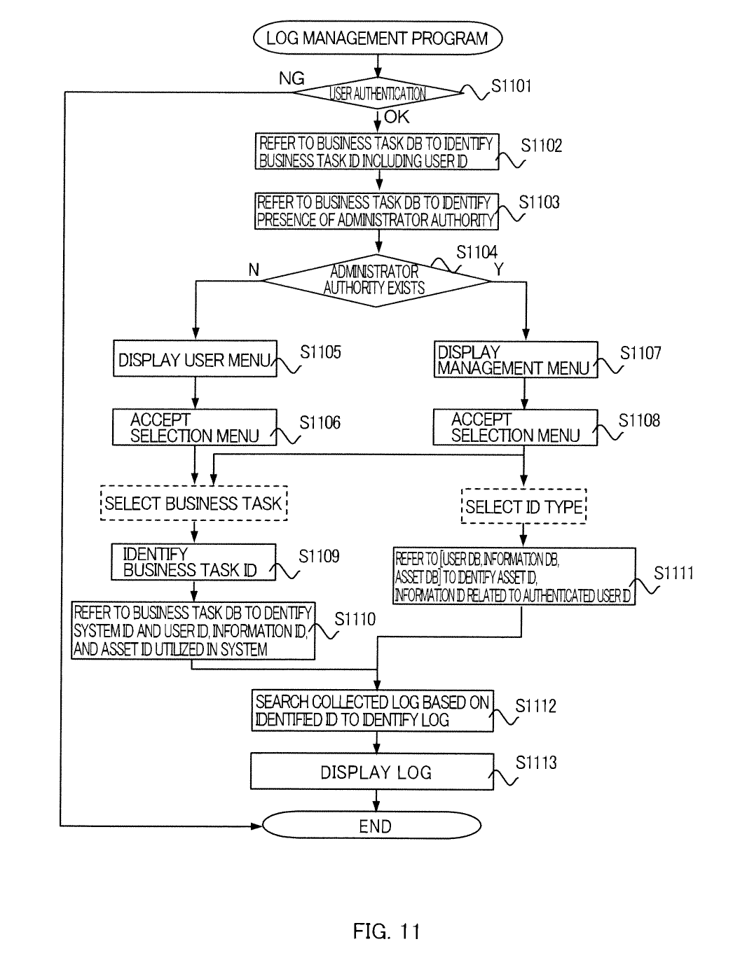

FIG. 11 is a diagram of a process flow example 3 of the ID management method of the present embodiment. A process flow of the log management program 15 will be described. The log management program 15 is responsible for a functions of collecting logs acquired by the apparatuses (such as the document management server 40, the entry/exit management server 50, the cabinet with authentication function 60, the client 70, and the notebook PC 78) and displaying necessary logs in response to requests from the business task director 2 and the user 3. The log management program 15 acquires log data of various operations recorded for the ID to he managed from the other apparatuses, which are the personnel management server 20, the asset management server 30, the document management server 40, the entry/exit management server 50, the cabinet with authentication function 60, the client 70, the notebook PC 78, etc., and retains the log data as the collected log 111 in the storage unit 17.

It is first assumed that the business task director 2 or the user 3 accesses the log management program 15 through the client 70. In this case, the log management program 15 performs user authentication by checking the user ID and the password received from the client 70 against a predetermined authentication table, for example (S1101). If the user authentication fails (S1101: NG), the process is terminated.

In contrast, if the user authentication succeeds (S1101: OK), the log management program 15 refers to the business task DB 113 to identify a business task ID including the authenticated user ID (S1102) and identifies the presence or absence of a business task with the administrator authority given to the authenticated user, that is the business task with the user ID set as the administrator ID 1135 (S1103).

If no business task with the administrator authority given to the authenticated user is identified (S1104: N), the log management program 15 reads data of a user menu from the storage unit 17 to return the data to the client 70 (S1105) and receives the selection of menu for accepting various designations related to log browse through this user menu (S1106).

In contrast, if a business task with the administrator authority given is identified (S1104: Y), the log management program 15 reads data of an administrator menu from the storage unit 17 to return the data to the client 70 (S1107) and receives the selection of menu for accepting various designations related to log browse through this administrator menu (S1108). The user menu is configured to display only the logs of business tasks related to a corresponding user while the administrator menu is configured to be capable of displaying not only the log of business tasks related to the user but also the logs related to IDs of business tasks in which the user is the administrator (FIG. 14).

After receiving the selection of the menu, when a given business task is selected in the corresponding menu, the log management program 15 identifies a selected business task ID (S1109) and uses the business task ID as a key to refer to the business task DB 113 to identify system IDs, user IDs, asset IDs, information IDs, etc., allocated to the corresponding business task (S1110).

On the other hand, after receiving the selection of the menu, when a given ID type is selected in the corresponding menu, the log management program 15 refers to the DB of the selected ID type, i.e., the user DB 112, the asset DB 114, or the information DB 116 to identify asset IDs and information IDs related to the authenticated user ID (S1111).

The log management program 15 uses the IDs identified at step S1110 or step S1111 as a key to search the collected log 111 and identifies corresponding log data necessary for display (S1112). The log management program 15 outputs the identified log data (to the output unit or) via the communication unit 16 to the client 70 (S1113) and terminates the process.

### Screen Example 1

An example of a screen output by the ID management server 10, the client 70, or the notebook PC 78 will then be described. FIG. 12 is a diagram of a display screen example 1 of the present embodiment. An ID management menu screen 900 and ID registration/change/delete screen 9011 (A to C) are depicted in FIG. 12.

The ID management menu screen 900 is a screen displayed on the client 70 after the system administrator 1, the business task director 2, or the user 3 accesses the ID management server 10 with the client 70 and the user authentication is performed (step S902, step S712, and S1101). On the ID management menu screen 900, icons 901 to 903 are arranged that accept utilization of three functions provided by the ID management server 10.

An example of the display screen will be described for the case of performing registration/change/deletion of an ID. It is assumed that an ID registration/change/delete button 901 is pressed on the ID management menu screen 900 by a user through the client 70.

In this case, the ID management program 11 reads data of the ID registration/change/delete screen 9011 from the storage unit 17 and returns the data to the client 70. The client 70 displays the screen data. The ID registration/change/delete screen 9011 displays a tab for each menu of new registration 9012, change 9013, and deletion 9014 and a user can utilize the function by pressing the tab the user wants to use.

Pressing of the new registration 9012 of ID leads to a registration/change/delete screen 9011A for new registration. This screen includes checkboxes (90121) for selecting any one of user, asset, and information as a type of an ID to be newly registered. The screen 9011A displays a form 90122 for entering information on the ID type selected by the checkbox 90121. Entry items included in the form 90122 are those corresponding to the ID type selected by the checkbox 90121. For example, in the case of the new registration of a user ID, the format is the same as that of the user DB 112 and has entry items such as user ID, name, department and job title. As a matter of course, the ID management server 10 retains in advance the data of the form 90122 to be displayed in accordance with the type selected by the checkbox 90121 in the storage unit 17.

The screen 9011A displays a list 90123 of distribution destination systems that match the ID type selected by the checkbox 90121. The user can customize the distribution destination by checking a line of the system that the user wants to distribute change information of an ID. In the example of the screen 9011A, the printing system, the document management system, and the entry/exit system are selected in the list 90123 of the distribution destination systems as indicated by an arrow 90124.

By pressing a registration button 90125 at the end, the registration process is performed for items entered in the form 90122 of the screen 9011A to the systems, etc., specified by the list 90123 of the distribution destination systems.

On the other hand, pressing of the ID change tab 9013 leads to a registration/change/delete screen 9011B for change. The screen 9011B displays a list 90131 for selecting a type of an ID to be changed, a list 90132 for selecting a corresponding ID in units of groups (that is the department of organization, etc.,) or IDs, and data items 90134 for entering the content of change in the selected ID to be changed. Therefore, for the ID to be changed, the user operates list 90132 to select a group or an ID including the content to be changed. In FIG. 12, an arrow 90133 selects a group in an attempt to make a change in “DEVELOPMENT DIVISION”.

The data items 90134 for entering the content of change consists of data items, content before change, content after change, and warning display. The contents of “data items” and “before change” are displayed by the ID management server 10 reading the data set in the DBs that manage the contents for the corresponding ID. Therefore, the user need only enter the data after the change.

The “warning display” is displayed only when the execution of the change process for the item entered in the data item 90134 has some sort of influence, which is in the case the ID is restricted from being changed. For example, if the user clicks “!” in the data item 90134 as depicted in FIG. 12, the ID management server 10 displays a dialogue 90135 that indicates “THIS CHANCE MAY AFFECT ANOTHER DB. CONTINUE TO REGISTER SUBSTITUTE?”. If “YES” is pressed in the dialogue 90135, the ID management program 11 makes a request to substitute registration to the system administrator 1 of the corresponding ID.

When the user enters all items to be changes and presses the registration button 90136, the ID management server 10 executes the change process described above (the flow of “change/deletion” in process flow 1) and the procedure is terminated.

On the other hand, pressing the ID deletion tag 9014 leads to a registration/change/delete screen 9011C for deletion. The screen 9011C displays a list 90141 for selecting a type of ID to be deleted and a list 90142 for selecting each ID in units of groups or IDs. Therefore, the user can perform a deletion procedure by selecting an ID to be deleted and pressing the delete button 90145. As is the case with the change process, in FIG. 12, an arrow 90143 makes a selection in an attempt to change the user name “ITO”. As is the case with the change process, when a user is selected, a warning dialogue 90144 is displayed if the deletion of the selected ID would have some sort of influence. Therefore, if the user follows the dialogue and selects “YES” to request substitute registration, the ID management program 11 makes a request for the substitute registration to the system administrator 1 of the corresponding ID.

With the screens described above, the system administrator 1 can perform the operations associated with the registration/change/deletion of an ID.

### Screen Example 2

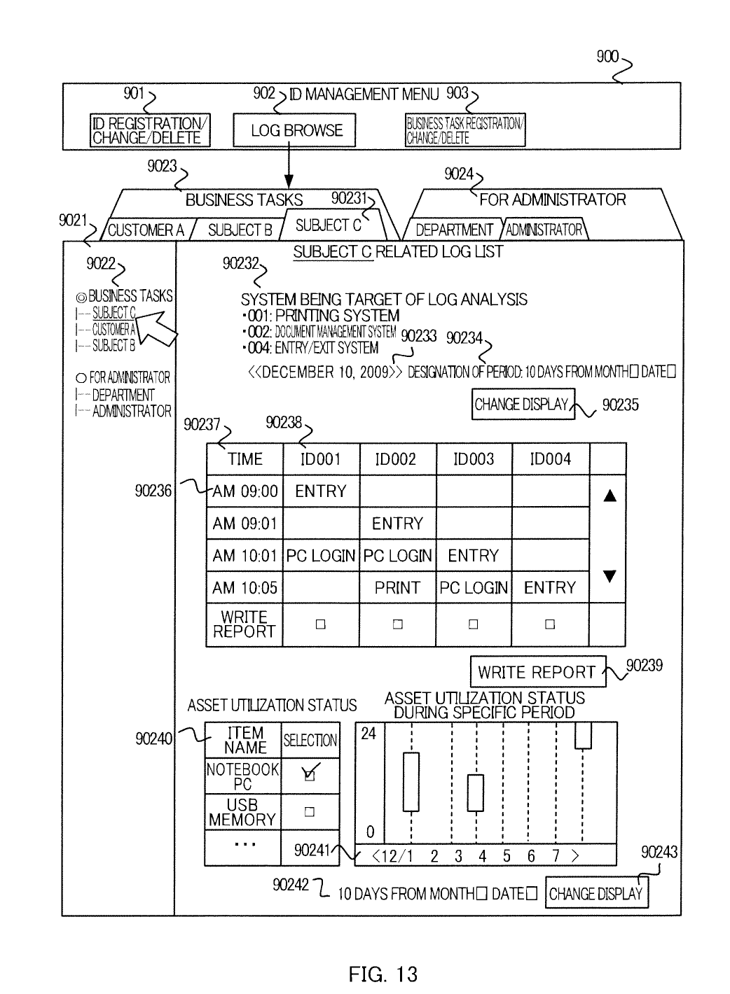

FIG. 13 is a diagram of a display screen example 2 of the present embodiment. An example of a screen output in association with the process flow of the log management program 15 will then be described. If a log browse button 902 is pressed in the ID management menu screen 900, the log management program 15 reads data of a log browse screen 9021 from the storage unit 17 and returns data to the client 70. The client 70 receives and displays the data.

This log browse screen 9021 is switched by the user pressing a corresponding menu in a log browse menu 9022 in the left field or by the user pressing a business task tab 9023 and an administrator tab 9024 displayed for each menu. The example of FIG. 13 is a display example when a business task tab 90231 of “SUBJECT C” is pressed and the log management program 15 displays the log related to “SUBJECT C” on the screen.

The screen displaying the log consists of log analysis target systems 90232, date 90233 of the browsed log, an entry form 90234 for designation of period, a display change button 90235, a log 90236, a report writing button 90239, an asset utilization status 90240, a graph 90241 of an asset utilization status during a specific period, an entry form 90242 for designating a display period, and a display change button 90243.

A user changes the date 90233 when desiring to browse the log on day basis or enters a start date and a period in the entry form 90234 for designating a period when desiring to browse the log of a certain period at one time, and presses the display change button 90235 at the end. The log management program 15 accordingly collects logs of the corresponding period and changes the display.

The log 90236 consists of time 90237 and ID 90238 registered in a business task and what is performed by what ID at what time can be recognized at a glance. The lowermost cell in a log of each ID is provided as a cell that enables selection of whether a report is to be made or not. For example, if a user checks a checkbox in the lowermost cell of a relevant ID and presses the report write button 90239, the log management program 15 collects only the logs related to the selected ID to create a report set in a predetermined format.

When the user wants to view a utilization status of an asset, the user need only check a selection field of the desired asset name displayed in the list 90240. In response to the user selecting an asset name in the list 90240, the log management program 15 collects the log of the corresponding asset and updates the utilization status graph 90241. This graph 90241 indicates date on the horizontal axis and time on the vertical axis representing the time zone while the corresponding asset is continuously utilized. The log management program 15 uses an asset ID as a key to extract the log of the corresponding asset from the collected log 111 and draws the graph 90241 from the information of a use period (which may be acquired by extracting data of time and date of consecutive usage for the same ID) indicated by the log.

From the graph 90241, a user can easily comprehend, for example, whether an asset utilization status is correct or whether an asset is being utilized. As is the case with the log displayed for each ID, if it is desired to display the log of a different period, a user can change the display by entering a start date and a period in the entry form 90242 to designate a period and pressing the display change button 90243.

### Screen Example 3

FIG. 14 is a diagram of a display screen example 3 of this embodiment. An example of a screen output in association with the process flow of the business task management program 14 will then be described. If a business task registration/change/delete button 903 is pressed in the ID management menu screen 900, the business task management program 14 reads data of a business task registration/change/delete screen 9031 from the storage unit 17 and returns the data to the client 70. The client 70 displays the screen 9031.

This business task registration/change/delete screen 9031 consists of a login name 9032, a request menu 9033, a list 9034 of business tasks related to a login user, a business task summary 9035, a list 9036 for registering IDs related to a business task, a list 9038 of available assets that are registration candidates, a utilized system registration menu 9040, an entry form 9041 of a workplace, a list 9042 of workplace candidates, a list 9043 of systems usable in a workplace, and a registration button 9044. Description will hereinafter be made in detail.

After the user authentication (step S712) of the process flow example 2 above, a user selects from the request menu 9033 whether “new registration” or “change/deletion” is to be performed. If “change/deletion” is selected, the business task management program 14 displays the list 9034 of business tasks related to the authenticated user and, therefore, the user can select a business task to be operated from the list 9034. The business task list 9034 consists of an entry field 90341 that accepts selection, registered business task names 90342, and business task statuses 90343.

If the user selects “new registration”, the user enters necessary items in the business task summary 9035. For the business task summary 9035, the user enters a business task ID 90351, a business task name 90352, a business task start date 90353, a scheduled business task end date 90354, and an administrator 90355. If “new registration” is selected, a new business task ID is automatically assigned by the business task management program 14 and, therefore, only items other than the business task ID 90351 is to be entered in the business task summary 9035. If “change/deletion” is selected, pre-registered data is displayed and, therefore, the user only needs to press the “change” button 90356 of the item to be changed to overwrite the content.

A registration process of ID to be correlated with a business task will be described in relation to the screen. In this case, a user can perform allocation by adding IDs to be registered, to the list 9036 for registering IDs of persons, items (assets), information, etc., to be allocated to a business task. The list 9036 is displayed by ID type and the IDs to be registered are displayed in each of the columns of person 90361, item 90362, and information 90363. IDs displayed in this case can be assumed to be, for example, a predetermined number of selected IDs not allocated to other business tasks in the business task DB 113 during the same period being available IDs, among IDs extracted by the business task management program 15 from each of the user DB 112, the asset DB 114, and the information DB 116.

In the case of adding an ID not displayed in the list 9036, a user presses the add button 9037. The business task management program 14 then lists available assets for the ID type selected by the user as described above, and displays the list 9038. Therefore, the user can select a desired one from the available assets indicated by the list 9038 and add the asset to the list 9036. If the user checks display 9039 of “LIMIT UTILIZATION ONLY TO USERS RELATED TO THE BUSINESS TASK” in this case, the business task management program 14 can limit users in response by setting usage limitation data for corresponding entries in the asset DB 31, 114 and the information DB 41, 116 such that “items” and “information” registered for a corresponding business task in the list 9036 are not available to those other than “persons” registered for the same corresponding business task (e.g., by setting only user IDs of persons registered for the corresponding business task in the user field for a relevant asset).

A user can select an arbitrary room usually utilized or a dedicated room as a place utilized for conducting a business task by the persons allocated to the corresponding business task. The user can make a request to utilize a room on the basis of a business task.

Therefore, the ID management server 10 preliminarily retains a workplace reservation management function (an existing meeting room reservation system may be applied). The business task management program 14 queries the workplace reservation management function to identify a currently available workplace, that is, a workplace not reserved by others and displays the workplace as an available room 90421 in the list 9042 of workplace candidates. Therefore, by checking a selection form 90422 for a room the user wants to utilize, the user can limit entities capable of utilizing the corresponding room during the duration of a business task. The corresponding room can be utilized only by persons, assets, and information allocated to the corresponding business task.

In response to the user selecting the available room 90421, the business task management program 14 identifies systems including the corresponding room as the place of use 1158 and displays the systems in a list 9045 of systems equipped in the selected room. The system list 9045 displays a system name 90431, a utilization entry form 90432, and a log acquisition form 90433. By checking a system the user wants to utilize in the system list 9045, the user can limit entities capable of utilizing the corresponding system during the duration of a business task. The corresponding system can be utilized only by persons, assets, and information allocated to the corresponding business task.

If a user checks the log acquisition form 90433 in the system list 9045, the log management program 15 extracts and presents only the log of the checked system to the user when the log is output on the basis of a business task as depicted in FIG. 13. Therefore, for example, if the access authority to a predetermined system must be managed and the utilization log of the system must be submitted because of a contract with a customer, this can easily be dealt with by a person in charge by checking the log acquisition 90433 in this list 9045.

Although the best modes for carrying out the present invention and the like have been specifically described, the present invention is not limited thereto and can variously be modified within a range not departing from the spirit of the present invention.

According to the present examples, unified management can be implemented between systems by identifying relationships among persons, items, and information under the management of an organization and relationships among business tasks, projects, and IDs. An audit can also be realized in accordance with business tasks by identifying utilization statuses of human resources, assets and information through logs.

Specifically, if a workplace, a worker, a utilized device, and available information must be clarified for a certain project, the project can be correlated with IDs of the resources in the ID management server to perform allocation and deletion of authority to utilize, log management, and utilization control at one time. This enables a project manager and the like to allocate and delete utilization authorities of persons, items, and information, which were conventionally managed by different departments, at one time to reduce the man-hour for management.

Since a log can be browsed and exported for each project, for example, if a contract requires validity of access history to be verified, the administrator's effort is unnecessary for identifying, extracting, and formatting logs relating to systems and the user operating with regard to the contract based on logs acquired from different systems, and only necessary logs can be promptly presented.

An exclusive access control can be implemented in association with project registration setting. For example, when the authority to utilize an asset is set in a certain project, if an attempt is made to utilize the same asset in another project, utilization can be limited by accepting from a user a selection between permit/do-not-permit. Therefore, when a user attempts to utilize a meeting room or an asset for a new business task or a meeting, the user can efficiently select a desired asset from the assets limited from being utilized. For an asset permitted to be utilized in a plurality of business tasks, the business task allowed to utilize the asset can be made clear and, therefore, a user can easily determine whether the asset should be freed from utilization in with the ending of a business task, for example.

Therefore, IDs of human resources, assets, and information in an organization can be managed in a cross-cutting manner. IDs of human resources, assets, and information in an organization can be managed in a cross-cutting manner in consideration of relationship with a business task such as a project.

From the present description, at least the following matters are revealed. In the ID management method, an information processing apparatus including an input unit, a communication unit, and a storage unit may execute the steps of: acquiring data of a database for ID management from the separate apparatus and retaining the data in the storage unit; checking the ID to be changed against the database for ID management in the storage unit to determine whether the ID is restricted from being changed in a corresponding database for ID management and transmitting a notification of a registration request for an alternative plan via the communicating unit to an administrator terminal of the separate apparatus retaining the corresponding database for ID management when the ID to be changed is an ID being restricted from being changed; receiving data of the alternative plan from the administrator terminal via the communication unit to identify the other apparatus utilizing an alternative ID indicated by the alternative plan from the system list; distributing change information relating to the alternative ID to the identified separate apparatus; and referring to the business task database retained in the storage unit managing IDs of human resources, assets, and information allocated to business tasks, identifying the alternative ID, and making a change related to the corresponding ID.

In the ID management method, the information processing apparatus including an output unit may execute the steps of: checking the ID to be changed against the databases for ID management in the storage unit to determine whether the ID is restricted from being changed in the corresponding databases for ID management, and outputting to the output unit or transmitting via the communication unit to a transmission source terminal of the ID change request alert information when the ID to be changed is an ID is restricted from being changed.

In the ID management method, the information processing apparatus may execute the steps of: referring to the system list retained in the storage unit and storing an ID utilization status of each of the other apparatuses when the ID change request received by the input unit or the communication unit indicates a new registration of ID, identifying other apparatuses utilizing the ID to be newly registered indicated by the ID change request, and outputting to the output unit or transmitting via the communication unit to a transmission source terminal of the ID change request a list of the identified other apparatuses; and receiving information of a corresponding other apparatus selected from the list from the input unit or from the transmission source terminal via the communication unit and distributing change information relating to the ID to be newly registered indicated by the ID change request to the corresponding other apparatus.

In the ID management method, the information processing apparatus may execute the steps of: accepting a business task registration request including designations of a business task to be registered and human resource, asset or information to be allocated to the corresponding business task by the input unit or the communication unit and registering the business task and an ID of the human resource, asset or information to be allocated thereto in the business task database; searching the system list with the ID of the human resource, asset or information indicated by the business task registration request to identify an other apparatus utilizing the ID indicated by the business task registration request; and distributing change information relating to the ID indicated by the business task registration request to the identified other apparatus.

In the ID management method, the information processing apparatus may execute the steps of: accepting a designation relating to a workplace of a business task when the business task registration request is accepted, searching the system list with information of the workplace to identify an other apparatus including the workplace as a place of use, and outputting to the output unit or transmitting via the communication unit to a transmission source terminal of the business task registration request a list of the identified other apparatuses; and receiving information of a corresponding other apparatus selected from the list from the input unit or from the transmission source terminal via the communication unit and distributing change information relating to the ID indicated by the business task registration request to the corresponding other apparatus.

In the ID management method, the information processing apparatus may execute the steps of: acquiring log data of various operations recorded for IDs to be managed from the other apparatuses and retaining the log data in the storage unit; and extracting log data of corresponding IDs from the storage unit for an ID group allocated to each business task in the business task database or for each ID included in the log data retained in the storage unit and outputting the log data to the output unit or to a predetermined terminal via the communication unit.

In the ID management method, the information processing apparatus may execute the steps of acquiring data of the databases for ID management from the separate apparatuses and retaining the data in the storage unit; and identifying an asset or information whose administrator is a corresponding person in the databases for ID management, or a business task in which the corresponding person is involved with the business task database, using an ID of an applicant indicated by the log browsing request as a key, when a log browsing request is received via the input unit or the communication unit, and extracting log data of the corresponding ID from the storage unit and outputting the log data to the output unit or to a predetermined terminal via the communication unit, using an ID of the identified asset or information or ID group allocated to the business task as a key.

What is claimed is:

1. An ID management method wherein an information processing apparatus, capable of communicating over a network with other apparatuses respectively controlling IDs of human resources, assets, and information, including an input unit, a communication unit, and a storage unit, executes the steps of:
referring to a system list, retained in the storage unit, storing an ID utilization status of each of the other apparatuses, when an ID change request is received by the input unit or the communication unit, and identifying an other apparatus utilizing an ID to be changed indicated by the ID change request;
distributing change information relating to the ID to be changed indicated by the ID change request to the identified other apparatus; and
referring to a business task database, retained in the storage unit, managing IDs of human resources, assets, and information allocated to business tasks, identifying the ID to be changed indicated by the ID change request, and making a change relating to the corresponding ID.

2. The ID management method of claim 1, wherein the information processing apparatus executes the steps of:
acquiring data of a database for ID management from the separate apparatus and retaining the data in the storage unit;
checking the ID to be changed against the database for ID management in the storage unit to determine whether the ID is restricted from being changed in a corresponding database for ID management and transmitting a notification of a registration request for an alternative plan via the communicating unit to an administrator terminal of the separate apparatus retaining the corresponding database for ID management when the ID to be changed is an ID being restricted from being changed;
receiving data of the alternative plan from the administrator terminal via the communication unit to identify the other apparatus utilizing an alternative ID indicated by the alternative plan from the system list;
distributing change information relating to the alternative ID to the identified separate apparatus; and
referring to the business task database retained in the storage unit managing IDs of human resources, assets, and information allocated to business tasks, and identifying the alternative ID to make a change related to the corresponding ID.

3. The ID management method of claim 2, wherein the information processing apparatus including an output unit, executes a step of checking the ID to be changed against the databases for ID management in the storage unit to determine whether the ID is restricted from being changed in the corresponding databases for ID management, and outputting to the output unit or transmitting via the communication unit to a transmission source terminal of the ID change request alert information when the ID to he changed is an ID is restricted from being changed.

4. The ID management method of claim 1, wherein the information processing apparatus executes the steps of:
referring to the system list retained in the storage unit and storing an ID utilization status of each of the other apparatuses when the ID change request received by the input unit or the communication unit indicates a new registration of ID, identifying other apparatuses utilizing the ID to be newly registered indicated by the ID change request, and outputting to the output unit or transmitting via the communication unit to a transmission source terminal of the ID change request a list of the identified other apparatuses; and
receiving information of a corresponding other apparatus selected from the list from the input unit or from the transmission source terminal via the communication unit and distributing change information relating to the ID to be newly registered indicated by the ID change request to the corresponding other apparatus.

5. The ID management method of claim 1, wherein the information processing apparatus executes the steps of:
accepting a business task registration request including designations of a business task to be registered and human resource, asset or information to be allocated to the corresponding business task by the input unit or the communication unit and registering the business task and an ID of the human resource, asset or information to be allocated thereto in the business task database;
searching the system list with the ID of the human resource, asset or information indicated by the business task registration request to identify an other apparatus utilizing the ID indicated by the business task registration request; and
distributing change information relating to the ID indicated by the business task registration request to the identified other apparatus.

6. The ID management method of claim 5, wherein the information processing apparatus executes the steps of:
accepting a designation relating to a workplace of a business task when the business task registration request is accepted, searching the system list with information of the workplace to identify an other apparatus including the workplace as a place of use, and outputting to the output unit or transmitting via the communication unit to a transmission source terminal of the business task registration request a list of the identified other apparatuses; and
receiving information of a corresponding other apparatus selected from the list from the input unit or from the transmission source terminal via the communication unit and distributing change information relating to the ID indicated by the business task registration request to the corresponding other apparatus.

7. The ID management method of claim 1, wherein the information processing apparatus executes the steps of:
acquiring log data of various operations recorded for IDs to be managed from the other apparatuses and retaining the log data in the storage unit; and
extracting log data of corresponding IDs from the storage unit for an ID group allocated to each business task in the business task database or for each ID included in the log data retained in the storage unit and outputting the log data to the output unit or to a predetermined terminal via the communication unit.

8. The ID management method of claim 7, wherein the information processing apparatus executes the steps of:
acquiring data of the databases for ID management from the separate apparatuses and retaining the data in the storage unit; and
identifying an asset or information whose administrator is a corresponding person in the databases for ID management, or a business task in which the corresponding person is involved with the business task database, using an ID of an applicant indicated by the log browsing request as a key, when a log browsing request is received via the input unit or the communication unit, and extracting log data of the corresponding ID from the storage unit and outputting the log data to the output unit or to a predetermined terminal via the communication unit, using an ID of the identified asset or information or ID group allocated to the business task as a key.

9. An ID management system that is an information processing system capable of communicating over a network with other apparatuses respectively managing IDs of human resources, assets, and information, comprising:
an input unit;
a communication unit;
a storage unit;
a unit of referring to a system list, retained in the storage unit, storing an ID utilization status of each of the other apparatuses when an ID change request is received by the input unit or the communication unit, and identifying an other apparatus utilizing an ID to be changed indicated by the ID change request;
a unit of distributing, to the identified other apparatus, change information relating to the ID to be changed indicated by the ID change request; and
a unit of referring to a business task database, retained in the storage unit, managing IDs of human resources, assets, and information allocated to business tasks, identifying the ID to be changed indicated by the ID change request, and making a change relating to the corresponding ID.

10. A computer-readable recording medium containing a computer software program causing an information processing apparatus capable of communicating over a network with other apparatuses respectively managing IDs of human resources, assets, and information, including an input unit, a communication unit, and a storage unit, to execute the steps of:
referring to a system list, retained in a storage unit, storing ID utilization status of each of the other apparatuses when an ID change request is received by an input unit or a communication unit, and identifying an other apparatus utilizing an ID to be changed indicated by the ID change request;
distributing, to the identified separate apparatus, change information relating to the ID to be changed indicated by the ID change request; and
referring to a business task database, retained in the storage unit, managing IDs of human resources, assets, and information allocated to business tasks, identifying the ID to be changed indicated by the ID change request, and making a change relating to the corresponding ID.
